(19) United States
(12) Patent Application Publication
(10) Pub. No.: US 2025/0326671 A1
(43) Pub. Date: Oct. 23, 2025

(54) ELECTROCHEMICAL WATER TREATMENT METHOD USING SELECTIVE ION SEPARATION

(71) Applicant: SK INNOVATION CO., LTD., Seoul (KR)

(72) Inventors: Yoon Hyuk JANG, Daejeon (KR); Tae Wan KIM, Daejeon (KR); Tea Young LEE, Daejeon (KR); Tae Hwa JEON, Daejeon (KR); Ae Jung HONG, Daejeon (KR)

(21) Appl. No.: 19/185,251

(22) Filed: Apr. 22, 2025

(30) Foreign Application Priority Data
Apr. 22, 2024 (KR) 10-2024-0053608

(51) Int. Cl. C02F 9/00; C02F 1/44; C02F 1/467; C02F 1/52; C02F 5/02; C02F 101/16; C02F 101/30

(52) U.S. Cl. CPC C02F 9/00; C02F 1/441; C02F 1/442; C02F 1/4672; C02F 1/4676; C02F 1/5245; C02F 5/02; C02F 2101/163; C02F 2101/30

(57) ABSTRACT

A method of removing pollutants from wastewater, the method including a) separating the wastewater into first treated water containing monovalent ions and second treated water containing multivalent ions, b) concentrating the monovalent ions in the first treated water to produce concentrated water, c) electrochemically reducing nitric acid in the concentrated water, and d) electrochemically oxidizing organic matter in the second treated water. According to the above method, the pollutants in the wastewater can be removed efficiently and environmentally.

### CROSS REFERENCE TO RELATED APPLICATION

The present application claims priority to Korean Patent Application No. 10-2024-0053608, filed Apr. 22, 2024, the entire contents of which are incorporated herein by reference.

### BACKGROUND OF THE INVENTION

### Field of the Invention

The embodiments of the present disclosure relate to an electrochemical water treatment method using selective ion separation.

### Description of the Related Art

As water resource supply conditions become more difficult due to factors such as regional imbalances in water resource distribution and droughts caused by climate change, the need to reuse previously used water resources is increasing. However, during a water reuse process, concentrated water with a high ion concentration and a high non-degradable organic matter content is generated, necessitating treatment of this concentrated water.

Due to climate change such as global warming, interest in the environment has recently been continuously increasing. This has led to stricter discharge requirements for pollutants such as non-biodegradable organic matter in a water system.

For the above reasons, research and development on water treatment technologies that can more efficiently and effectively remove pollutants in a water system are actively being conducted.

The foregoing is intended merely to aid in the understanding of the background of the present disclosure, and is not intended to mean that the embodiments of the present disclosure fall within the purview of the related art that is already known to those skilled in the art.

### SUMMARY

Accordingly, the embodiments of the present disclosure have been made keeping in mind the above problems occurring in the related art, and one embodiment of the present disclosure is to provide an electrochemical water treatment method using selective ion separation, the method being capable of effectively removing pollutants or organic matter in a water system without producing toxic by-products.

According to an embodiment of the present disclosure, there is provided a method of removing pollutants from wastewater, the method including: a) separating the wastewater into first treated water containing monovalent ions and second treated water containing multivalent ions, wherein the first treated water comprises a higher concentration of monovalent ions compared with the wastewater, and the second treated water comprises a higher concentration of multivalent ions compared with the wastewater; b) concentrating the monovalent ions in the first treated water to produce concentrated water; c) electrochemically reducing nitric acid in the concentrated water; and d) electrochemically oxidizing organic matter in the second treated water.

In an embodiment, operation (a) may be performed by a membrane separation process, a dialysis process, an ion exchange process, or a combination thereof.

In an embodiment, the first treated water may contain a reduced concentration of multivalent ions compared to multivalent ions contained in the wastewater.

In an embodiment, the second treated water may contain a reduced concentration of chlorine ions compared to chlorine ions contained in the wastewater.

In an embodiment, the method may further include pre-treating the wastewater prior to the operation (a).

In an embodiment, the pre-treating of the wastewater may include a pH control process, a lime-soda process, or a combination thereof.

In an embodiment, the method may further include adding a separate salt into the wastewater prior to the operation (a).

In an embodiment, operation (b) may be performed by a membrane process, an evaporation process, or a combination thereof.

In an embodiment, the method may further include reducing an amount of monovalent ions in the second treated water after operation (a).

In an embodiment, the method may further include mixing the first treated water after operation (c) and the second treated water after operation (d).

In an embodiment, the method may further include removing inorganic carbon in the concentrated water after operation (b).

In an embodiment, operation (d) may be performed by an electrochemical oxidation process, a Fenton oxidation process, an ozone oxidation process, a UV oxidation process, a hydrogen peroxide oxidation process, a catalytic oxidation process, or a combination thereof.

According to the embodiments of the present disclosure, it is possible to achieve environmentally friendly and efficient water treatment.

### BRIEF DESCRIPTION OF THE DRAWINGS

The above and other objectives, features, and other advantages of the embodiments of the present disclosure will be more clearly understood from the following detailed description when taken in conjunction with the accompanying drawings, in which:

FIG. 1 is a simplified process flow schematic illustrating a method of removing pollutants according to an embodiment of the present disclosure;

FIG. 2 is a simplified process flow schematic illustrating a method of removing pollutants according to an embodiment of the present disclosure;

FIG. 3 is a simplified process flow schematic illustrating a method of removing pollutants according to an embodiment of the present disclosure;

FIG. 4 is a simplified process flow schematic illustrating a method of removing pollutants according to an embodiment of the present disclosure;

FIG. 5 is a simplified process flow schematic illustrating a method of removing pollutants according to an embodiment of the present disclosure;

FIG. 6 is a simplified process flow schematic illustrating a method of removing pollutants according to an embodiment of the present disclosure;

FIG. 7 is a graph illustrating a plot of change in total organic carbon removal rate over time according to an embodiment of the present disclosure; and

FIG. 8 is a simplified process flow schematic illustrating a method of removing pollutants according to an embodiment of the present disclosure.

### DETAILED DESCRIPTION

Hereinbelow, the embodiments of the present disclosure will be described in detail with reference to the accompanying drawings. However, disclosed herein are specific embodiments that illustrate the technical concepts and principles of the present disclosure, and it should be emphasized that the embodiments are not limited to the specific embodiments illustrated.

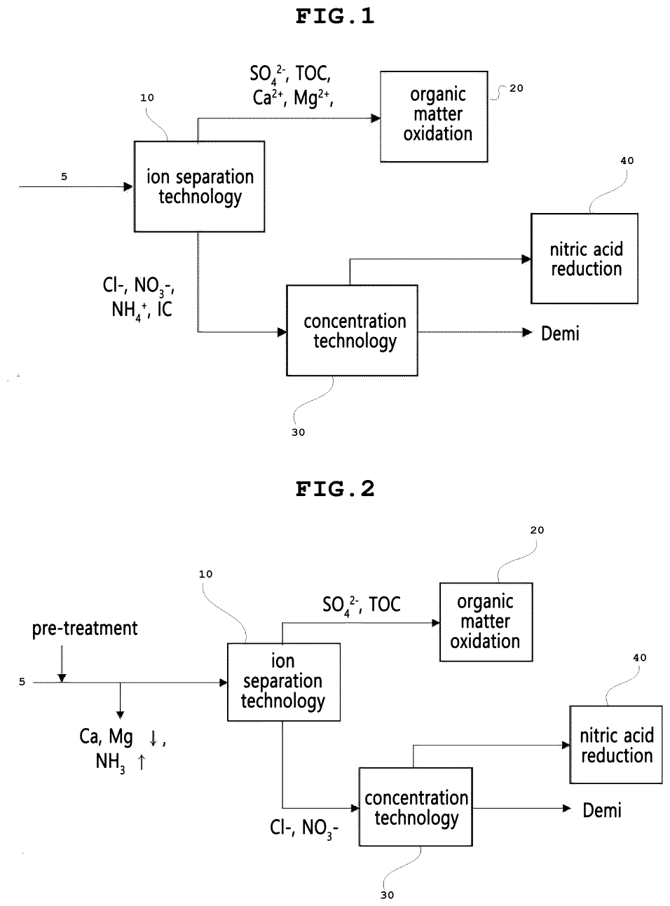

According to an embodiment of the present disclosure, a method of removing pollutants from wastewater is provided. The method includes a) separating the wastewater into first treated water containing monovalent ions and second treated water containing multivalent ions, wherein the first treated water comprises a higher concentration of monovalent ions compared with the wastewater, and the second treated water comprises a higher concentration of multivalent ions compared with the wastewater; b) concentrating the monovalent ions in the first treated water to produce concentrated water; c) electrochemically reducing nitric acid in the concentrated water; and d) electrochemically oxidizing organic matter in the second treated water. The schematic flow of the method is illustrated in FIG. 1 which shows an ion separation technology treatment station 10, an organic matter oxidation treatment station 20 a concentration technology treatment station 30 and a nitric acid reduction treatment station 40. Wastewater 5 is first treated in the ion separation technology station 10 and two treated water streams are produced including a first treated water containing the monovalent ions, e.g., Cl⁻; NO₃⁻, NH₄⁺, and a second treated water containing multivalent ions, e.g., SO₄²⁻, Ca²⁺, Mg²⁺.

The separating of the wastewater 5 into the first treated water containing the monovalent ions and the second treated water containing the multivalent ions (operation (a)) is an operation of selectively separating ions contained in the wastewater according to their ion valence so that each treated water is introduced into an appropriate electrochemical water treatment operation. The first treated water separated in operation (a) has a higher concentration of monovalent ions than the concentration of monovalent ions contained in the wastewater, and may contain a trace amount of multivalent ions that remain unseparated in operation (a). The second treated water has a higher concentration of multivalent ions than the concentration of multivalent ions contained in the wastewater, and may contain a trace amount of monovalent ions that remain unseparated in operation (a). Operation (a) is not particularly limited as long as it is a method that can separate monovalent ions and multivalent ions. Additionally, in operation (a), inorganic carbon (IC) may be separated into the first treated water as a monovalent ion mainly in the form of HCO₃₋, a very small amount of total organic carbon (TOC) may be separated into the first treated water, and the remaining majority of TOC may be separated into the second treated water. In an embodiment, operation (a) may be performed at least two times.

In an embodiment, operation (a) may be performed by a membrane separation process, a dialysis process, an ion exchange process, or a combination thereof. The membrane separation process includes separating the monovalent ions and the multivalent ions by using a membrane such as, for example, a nanofilter and an ion exchange membrane. When the nanofilter is used, the monovalent ions and the multivalent ions may be separated from each other through the difference in ion size. When the ion exchange membrane is used, the monovalent ions and the multivalent ions may be separated through the property of the ion exchange membrane to selectively transmit only specific ions. The dialysis process includes separating the ions by alternately arranging ion exchange membranes that can selectively transmit only anions or cations in a reactor to form a plurality of chambers in the reactor, and adding the wastewater so that a chamber containing a concentrated solution containing cations, anions, and their salts in the wastewater and another chamber containing demineralized water are alternately generated. When voltage is applied after adding the wastewater into the reactor, the dialysis process may be referred to as electrodialysis. The ion exchange process is a process that separates specific ions in the wastewater by injecting an ion exchange resin made of a polymer having a strongly acidic or strongly basic functional group into the wastewater and exchanging ions in the resin with specific ions in the wastewater. Any one of the above methods or a combination thereof may be used to separate the monovalent and the multivalent ions in the wastewater. In particular, when the membrane separation process using the nanofilter is used, the monovalent ions and the multivalent ions in the wastewater may be effectively separated.

In an embodiment of the present disclosure, the first treated water may contain a reduced concentration of multivalent ions compared to the multivalent ions contained in the wastewater. As described above, the first treated water may contain the monovalent ions in a concentration exceeding the concentration of the monovalent ions contained in the wastewater, and may contain a trace amount of multivalent ions that remain unseparated in operation (a). The trace amount of the multivalent ions refers to multivalent ions that are inevitably contained in the first treated water because the ion separation efficiency of operation (a) is not 100% when a large amount of multivalent ions is contained in the wastewater. Among the multivalent ions contained in the first treated water, Ca ions and Mg ions may reduce reduction performance when reducing nitric acid in the first treated water in a subsequent operation. As described above, the first treated water may contain only an inevitable trace amount of multivalent ions, thereby preventing degradation of nitrate reduction performance caused by presence of Ca ions and Mg ions. In an embodiment of the present disclosure, the first treated water may contain 0% to 10% of the multivalent ions per unit volume relative to the weight of the multivalent ions per unit volume contained in the wastewater prior to the operation (a), specifically 0% to 7%, more specifically 0% to 5% of the multivalent ions per unit volume relative to the weight of the multivalent ions per unit volume contained in the wastewater prior to the operation (a). Additionally, the first treated water may contain 105% to 200% of the monovalent ions per unit volume relative to the weight of the monovalent ions per unit volume contained in the wastewater prior to the operation (a), specifically 105% to 130%, more specifically 110% to 125% or 115% to 120% of the monovalent ions per unit volume relative to the weight of the monovalent ions per unit volume contained in the wastewater prior to the operation (a). In an embodiment of the present disclosure, the second treated water may contain a reduced concentration of chlorine ions compared to chlorine ions contained in the wastewater. As described above, the second treated water may contain the multivalent ions in a concentration exceeding the concentration of the multivalent ions contained in the wastewater, and may contain a trace amount of monovalent ions that remain unseparated in operation (a). The trace amount of monovalent ions refers to monovalent ions that are inevitably contained in the second treated water because the ion separation efficiency of operation (a) is not 100% when a large amount of monovalent ions is contained in the wastewater. The trace amount of monovalent ions may include chlorine ions (Cl⁻). The chlorine ions contained in the second treated water may generate a large amount of chlorine by-products when organic matter in the second treated water is oxidized in a subsequent operation. These chlorine by-products may have a negative impact on the environment because they are toxic. The second treated water may contain only an inevitable trace amount of chlorine ions, thereby minimizing production of chlorine by-products during oxidation of organic matter. In an embodiment of the present disclosure, the second treated water may contain 0% to 20% of the monovalent ions per unit volume relative to the weight of the monovalent ions per unit volume contained in the wastewater prior to the operation (a), specifically 0% to 15%, more specifically 0% to 10% of the monovalent ions per unit volume relative to the weight of the monovalent ions per unit volume contained in the wastewater prior to the operation (a). In particular, the second treated water may contain 0% to 5% of the chlorine ions per unit volume relative to the weight of the chlorine ions per unit volume contained in the wastewater prior to the operation (a), specifically 0% to 4%, more specifically 0% to 3% of the chlorine ions per unit volume relative to the weight of the chlorine ions per unit volume contained in the wastewater prior to the operation (a). Additionally, the second treated water may contain 200% to 2000% of the multivalent ions per unit volume relative to the weight of the multivalent ions per unit volume contained in the wastewater prior to the operation (a), specifically 200% to 1300% or 200% to 1000%, more specifically 300% to 900% or 500% to 700% of the multivalent ions per unit volume relative to the weight of the multivalent ions per unit volume contained in the wastewater prior to the operation (a).

In an embodiment of the present disclosure, the method may further include pre-treating the wastewater prior to the operation (a). When the amount of a specific ion in the wastewater is excessively high, for example, when the concentration of monovalent anions in the wastewater is higher than the concentration of monovalent cations in the wastewater, a large amount of monovalent anions may be contained in the second treated water. This may result in undesirable by-products as described above. On the contrary, when the concentration of the monovalent cations in the wastewater is higher than the concentration of the monovalent anions in the wastewater, a large amount of monovalent cations may be contained in the second treated water. This may require additional treatment to meet discharge standards. The pre-treating of the wastewater may include removing from the wastewater a part of those ions that are present in a high amount in the wastewater prior to the operation (a). The pre-treatment of the wastewater may may be performed, for example, when there is an imbalance or large difference between the amounts of monovalent cations and monovalent anions in the wastewater.

The pre-treating of the wastewater is not particularly limited as long as it is a method that can remove a high amount of specific ions from the wastewater. The schematic flow of the method of removing the pollutants from the wastewater including the pre-treating of the wastewater prior to the operation (a) is illustrated in FIG. 2.

In an embodiment of the present disclosure, the pre-treating of the wastewater may include a pH control process, a lime-soda process, or a combination thereof. The pH control process includes removing Ca ions, Mg ions, and NH₄⁺ ions in the wastewater by increasing the pH of the wastewater. Through this process, a scale problem of the method may be reduced, and the time required for post-treating ammonia in a subsequent operation may be reduced. The lime-soda process includes removing the multivalentions such as Ca ions and/or Mg ions present in the wastewater by adding sodium carbonate and sodium hydroxide to the wastewater, stirring the mixture to induce a chemical reaction, and then separating and removing the resulting salt through precipitation.

In an embodiment of the present disclosure, the method may further include adding a separate salt into the wastewater prior to the operation (a). As described above, when there is a difference in the concentrations of the monovalent cations and the monovalent anions in the wastewater, the selective ion separation efficiency may be reduced. To prevent this, prior to the operation (a), a salt of a monovalent cation and a multivalent anion or a salt of a multivalent cation and a monovalent anion may be added to the wastewater to balance the concentrations of the monovalent cations and monovalent anions. When necessary, the salt may be added to create an imbalance of the monovalent cations and the monovalent anions. For example, the concentration of the monovalent cations in the wastewater may be made higher than the concentration of the monovalent anions by addition of the salt. In this case, the concentration of the monovalent anions flowing into the first treated water may be increased further, so the concentration of the monovalent anions in the second treated water may be reduced compared to when the balance of cations and anions in the wastewater is maintained. This may reduce production of chlorine by-products caused by the presence of the chlorine ions among the monovalent anions during oxidation of the organic matter in the second treated water. Referring to FIG. 8, Na₂SO₄ may be added to the wastewater prior to the operation (a) to balance the concentrations of the monovalent cations and the monovalent anions.

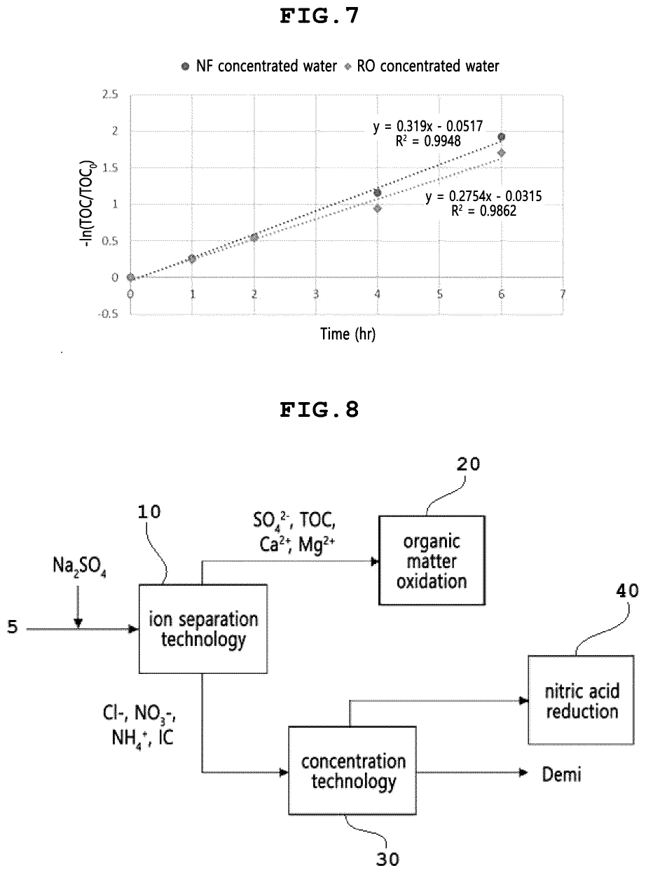

The method includes concentrating the monovalent ions in the first treated water to produce the concentrated water (operation (b)) after operation (a). In operation (a), more than 80% of water in the wastewater may flow into the first treated water. That is, after operation (a), the monovalent ions in the first treated water may be concentrated compared to the monovalent ions in the wastewater, but the degree of concentration is not large. Operation (b) is an operation of further concentrating the monovalent ions in the first treated water. Conventional demi water production involves two concentration operations. The method may be cost-effectively implemented by replacing one of the concentration operations with a selective ion separation operation. Additionally, the method may increase the organic matter oxidation efficiency by replacing one of the concentration operations with a selective ion separation operation. Referring to FIG. 7, illustrated is data comparing the reactivity for organic matter oxidation between concentrated water (RO concentrated water) obtained through two concentration operations and concentrated water (NF concentrated water) obtained by separating the first treated water through the nanofilter and then concentrating the first treated water one time. In FIG. 7, it can be confirmed that the NF concentrated water has a high reactivity for oxidation of organic matter (total organic carbon, TOC) at the same oxidation time. This is believed to be because, in the case of the NF concentrated water, a side reaction in which hydroxyl radicals are used to oxidize chlorine ions (Cl⁻) does not occur.

In an embodiment of the present disclosure, operation (b) may be performed by a membrane process, an evaporation process, or a combination thereof. The membrane process is a process that concentrates the monovalent ions in the first treated water using a reverse osmosis membrane and may be performed in the following manner. The first treated water may be added into one of two regions of the reactor divided by the reverse osmosis membrane, and a liquid with a low concentration of monovalent ions may be added into the remaining region. Then, a pressure higher than the osmotic pressure may be artificially applied to the region where the first treated water is added so that the remaining liquid components, excluding the monovalent ions in the first treated water, are allowed to permeate through the reverse osmosis membrane into the region where the liquid with a low concentration of monovalent ions is added, thereby concentrating the monovalent ions in the first treated water. The evaporation process volatilizes the liquid components and increases the concentration of the monovalent ions by raising the temperature of the first treated water to a temperature exceeding the boiling point thereof. Through this process, the concentration of the monovalent ions in the first treated water may be significantly increased.

The method includes electrochemically reducing the nitric acid in the concentrated water (operation (c)). The nitric acid, which is a monovalent ion in the wastewater, may cause environmental pollution due to its toxicity when it is discharged without separate treatment. The method may solve the above problem by including the reducing of the nitric acid operation in the concentrated water. Specifically, in operation (c), the concentrated water containing the nitric acid may be added into the reactor including an anode and a cathode, electricity may be applied, and the concentrated water may be directly reduced at the cathode and converted into ammonia gas (NH₃) or nitrogen gas (N₂). That is, in operation (c), the nitric acid in the concentrated water may be converted into a gaseous state and volatilized. This may mitigate or prevent environmental pollution caused by the presence of nitric acid in a water system.

The method includes electrochemically oxidizing the organic matter in the second treated water (operation (d)). Operation (d) includes adding the second treated water into an electrochemical reactor 20 (also referred to as the organic matter oxidation treatment station 20) including an anode and a cathode, applying electricity, and removing the organic matter in the second treated water by oxidizing or decomposing the organic matter through ions or radicals generated at the electrodes. In operation (d), the organic matter in the second treated water may be removed, so the second treated water may have a water quality that is appropriate for discharge. Additionally, the second treated water may not contain monovalent ions including chlorine ions except for an inevitable trace amount, so generation of perchlorate caused by residual chlorine ions during oxidation of the organic matter in the second treated water may be prevented.

In an embodiment of the present disclosure, operation (d) may be performed by an electrochemical oxidation process, a Fenton oxidation process, an ozone oxidation process, a UV oxidation process, a hydrogen peroxide oxidation process, a catalytic oxidation process, or a combination thereof. The electrochemical oxidation process is a process that directly oxidizes the pollutants at an electrode that has been applied with electricity or indirectly oxidizes the pollutants by generating an oxidizing agent. The Fenton oxidation process is a process that generates hydroxyl radicals (OH radicals) through a catalytic reaction between the organic matter and hydrogen peroxide. The ozone oxidation process is a process that adds ozone (O₃) into the second treated water, applies electricity, generates radicals, and oxidizes and decomposes the organic matter in the second treated water using instability of the radicals. The UV oxidation process and the hydrogen peroxide oxidation process are processes that generate hydroxyl radicals by irradiating ozone with ultraviolet rays or reacting the ozone with hydrogen peroxide, and oxidizes and decomposes the organic matter using the radicals. The catalytic oxidation process is a process that directly oxidizes the organic matter using a catalyst or indirectly oxidizes the organic matter by generating an oxidizing agent. Through these processes, the organic matter in the second treated water may be effectively removed.

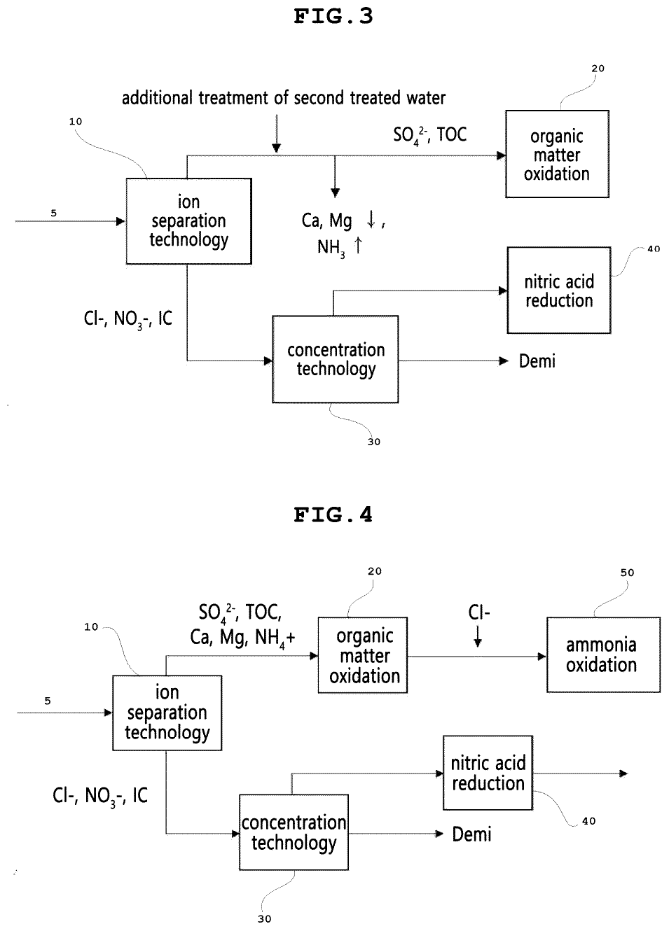

In an embodiment of the present disclosure, the method may further include reducing the amount of monovalent ions in the second treated water after operation (a). As described above, the amounts of monovalent cations and monovalent anions in the wastewater may not be balanced. In particular, when there is a difference in the amounts of monovalent cations and monovalent anions in the wastewater, the second treated water after operation (a) may also contain a large amount of monovalent ions. The reducing of the amount of monovalent ions in the second treated water may be performed in the same manner as the pre-treating of the wastewater, and may be performed only on the second treated water separated from the first treated water after operation (a), that is, on a smaller amount of treated water compared to the pre-treating of the wastewater, thereby exhibiting a higher monovalent ion removal efficiency. The reducing of the amount of monovalent ions in the second treated water after operation (a) may be performed as indicated in FIG. 3 by an “additional treatment of second treated water.” Additionally, the above operation may be performed by adding chlorine ions (Cl⁻) to the second treated water to induce ammonia oxidation (50) when a large amount of NH₄⁺ is contained as a monovalent ion in the second treated water. This may be performed as indicated by “Cl⁻” in FIG. 4.

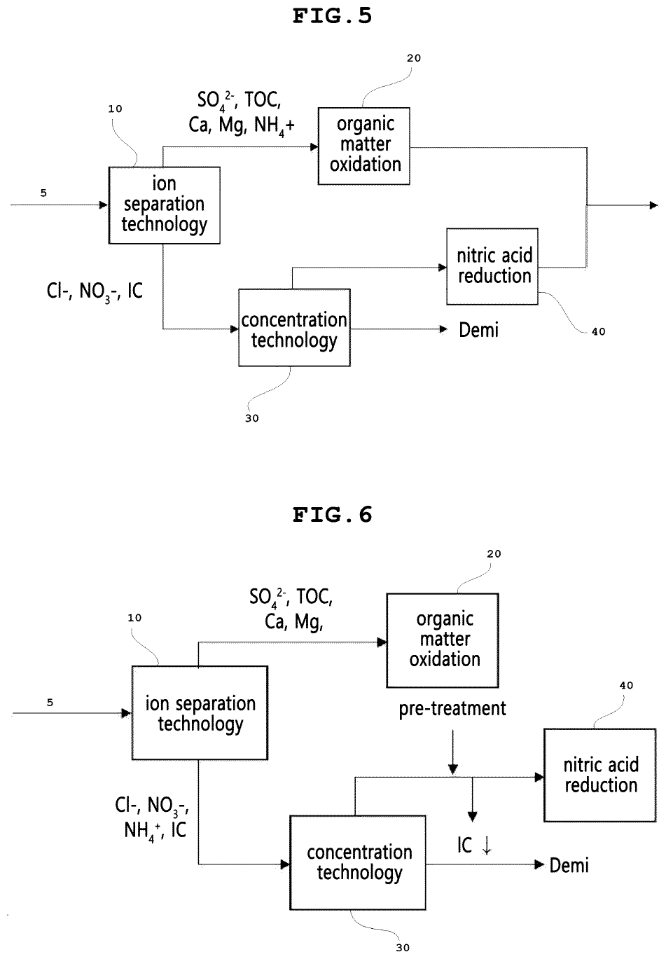

In an embodiment of the present disclosure, the method may further include mixing the first treated water after operation (c) and the second treated water after operation (d). As mentioned above, when the amount of monovalent ions, especially NH₄⁺, in the wastewater is high, NH₄⁺ ions may remain in the second treated water after operation (d). In this case, the first treated water after operation (c) may be mixed with the second treated water after operation (d), and while nitric acid reduction in operation (c) is performed at the cathode, NH₄⁺ remaining in the second treated water may be removed using OCl⁻ generated by oxidation of CI at the anode through a breakpoint chlorination method. The schematic flow of the method of removing the pollutants from the wastewater including the above operation is as illustrated in FIG. 5.

In an embodiment of the present disclosure, the method may further include removing inorganic carbon in the concentrated water after operation (b). The inorganic carbon in the concentrated water may competitively adsorb to the active sites of an electrode and inhibit a nitric acid reduction reaction. That is, when the amount of inorganic carbon in the concentrated water is high, the efficiency of the nitric acid reduction reaction may be reduced. Accordingly, in an embodiment of the present disclosure, the efficiency of the nitric acid reduction reaction may be improved by further including the removing of the inorganic carbon in the concentrated water after operation (b). The removing of the inorganic carbon in the concentrated water may be performed by pH control, chemical precipitation of inorganic carbon, degassing, or a combination thereof. The schematic flow of the method of removing the pollutants from the wastewater including the above operation is as illustrated in FIG. 6.

Hereinafter, a preferred example is presented to help understand the embodiments of the present disclosure. However, the following example is provided only to facilitate understanding of the embodiments, and the embodiments of the present disclosure are not limited thereto.

### Example

As illustrated in FIG. 2, a process was configured to include separating wastewater 5 into first treated water mainly containing monovalent ions and second treated water mainly containing multivalent ions (operation (a)); introducing the first treated water to the concentration technology station 30 (or reactor) for concentrating the monovalent ions in the first treated water to produce concentrated water (operation (b)); feeding the concentrated water to the nitric acid reduction treatment station 40 (or reactor) for reducing the nitric acid that is present in the concentrated water (operation (c)); and oxidizing the organic matter in the second treated water (operation (d)). Operation (a) was performed by adding the wastewater into a separator including a nanofilter (NF), and operation (b) was performed using a reverse osmosis membrane (RO). The pH, ionic conductivity, and organic matter and ion concentrations of the wastewater (feed) before introduction into the process and the feed after operations (a) to (c) are as illustrated in Table 1 below.

TABLE 1

| | | | | | T-N | | | | | | |
|---|---|---|---|---|---|---|---|---|---|---|---|
| | | | | | (total | | | | | | |
| | pH | Cond | TOC | IC | nitrogen) | Ca²⁺ | Mg²⁺ | Cl⁻ | SO₄²⁻ | NO₃⁻ | NH₄⁺ |
| Sample | — | mS/cm | mg/L | mg/L | mg/L | mg/L | mg/L | mg/L | mg/L | mg/L | mg/L |
| Feed | 7.65 | 7.51 | 6.74 | 12.04 | 2.53 | 42.4 | 6.4 | 174 | 3000 | 10 | <2 |
| (wastewater) | | | | | | | | | | | |
| First treated | 7.93 | 1.04 | 1.62 | 13.3 | 1.98 | 0.3 | 0 | 192 | 96 | 12 | <1 |
| water (after | | | | | | | | | | | |
| operation (a) | | | | | | | | | | | |
| Second treated | 6.91 | 39.86 | 51.81 | 2.048 | 8.52 | 454.9 | 54.6 | 5 | 27000 | <1 | <10 |
| water (after | | | | | | | | | | | |
| operation (a) | | | | | | | | | | | |
| Concentrated | 8.34 | 6.81 | 6.62 | 91.27 | 22.34 | 3.9 | 0.6 | 1000 | 766 | 82 | <2 |
| water (after | | | | | | | | | | | |
| operation (b) | | | | | | | | | | | |
| Demi water | 6.93 | 0.01 | 0.42 | 0.74 | 0 | 0 | 0 | 1 | <1 | <1 | <1 |
| (after | | | | | | | | | | | |
| operation (b) | | | | | | | | | | | |

Thereafter, the second treated water separated in operation (a) was introduced into the electrochemical reaction station 20 for electrochemical oxidation (operation (d)) to oxidize the organic matter, and the results are illustrated in Table 2 below.

TABLE 2

| Reaction time | TOC | TOC removal rate |
|---|---|---|
| hr | mg/L | % |
| 0 | 50.32 | |
| 1 | 38.58 | 23.33 |
| 2 | 29.21 | 41.95 |
| 4 | 15.81 | 68.58 |
| 6 | 7.37 | 85.35 |

From Table 2, it can be confirmed that the degree of organic matter removal increased over time.

The embodiments of the present disclosure have been described in detail through specific embodiments. The embodiments of the present disclosure are disclosed only for illustrative purposes and should not be construed as limiting the embodiments. It will be understood by those skilled in the art that the embodiments of the present disclosure can be modified or changed in various forms without departing from the technical scope of the present disclosure. Simple modifications or changes of the embodiments fall within the scope of the present disclosure, which will be more clearly understood by the accompanying claims. Furthermore, the embodiments may be combined to form additional embodiments.

What is claimed is:

1. A method of removing pollutants from wastewater, the method comprising:
a) separating the wastewater into a first treated water containing monovalent ions and a second treated water containing multivalent ions, wherein the first treated water comprises a higher concentration of monovalent ions compared with the wastewater, and the second treated water comprises a higher concentration of multivalent ions compared with the wastewater;
b) concentrating the monovalent ions in the first treated water to produce concentrated water;
c) electrochemically reducing nitric acid in the concentrated water; and
d) electrochemically oxidizing organic matter in the second treated water.

2. The method of claim 1, wherein the operation (a) is performed by a membrane separation process, a dialysis process, an ion exchange process, or a combination thereof.

3. The method of claim 1, wherein the first treated water contains a reduced concentration of multivalent ions compared to multivalent ions contained in the wastewater.

4. The method of claim 1, wherein the second treated water contains a reduced concentration of chlorine ions compared to chlorine ions contained in the wastewater.

5. The method of claim 1, further comprising
pre-treating the wastewater prior to the operation (a).

6. The method of claim 5, wherein the pre-treating of the wastewater comprises a pH control process, a lime-soda process, or a combination thereof.

7. The method of claim 1, further comprising
adding a separate salt into the wastewater prior to the operation (a).

8. The method of claim 1, wherein operation (b) is performed by a membrane process, an evaporation process, or a combination thereof.

9. The method of claim 1, further comprising
reducing an amount of monovalent ions in the second treated water after operation (a).

10. The method of claim 1, further comprising
mixing the first treated water after operation (c) and the second treated water after operation (d), and removing inorganic carbon in the concentrated water after operation (b).

11. The method of claim 1, wherein operation (d) is performed by an electrochemical oxidation process, a Fenton oxidation process, an ozone oxidation process, a UV oxidation process, a hydrogen peroxide oxidation process, a catalytic oxidation process, or a combination thereof.

12. A method of removing pollutants from wastewater, the method comprising:
subjecting wastewater to at least one of a membrane separation process, a dialysis process, and an ion exchange process to separate the wastewater into a first water stream comprising monovalent ions and a trace amount of multivalentions, and a second water containing multivalent ions and a trace amount of monovalent ions;
concentrating the monovalent ions in the first treated water to produce concentrated water;
electrochemically reducing nitric acid in the concentrated water; and
electrochemically oxidizing organic matter in the second treated water.
